(19) United States
(12) Patent Application Publication
(10) Pub. No.: US 2024/0289898 A1
(43) Pub. Date: Aug. 29, 2024

(54) BLOCKCHAIN-BASED NON-FUNGIBLE TOKEN SYSTEM AND METHOD FOR AGRICULTURAL INDUSTRY SUPPLY CHAINS

(71) Applicant: Preska Thomas, Port Saint Lucie, FL (US)

(72) Inventor: Preska Thomas, Port Saint Lucie, FL (US)

(21) Appl. No.: 18/114,254

(22) Filed: Feb. 26, 2023

(51) Int. Cl. G06Q 10/0833; G06Q 50/02

(52) U.S. Cl. CPC G06Q 50/02; G06Q 2220/00

(57) ABSTRACT

A system for utilizing non-fungible tokens to track movement of goods through supply chains is provided. The system comprises a computer and an application executing thereon that creates a smart contract for deployment on a blockchain, the smart contract directed to defining rules for non-fungible tokens (NFT), wherein each NFT represents a unique agricultural product. The system also programs the smart contract to capture and store data in the NFTs about the products. The system also programs the smart contract to include algorithms in the NFTs for tracking movement of the products through their supply chains. The system also deploys the smart contract in the blockchain. The blockchain stores data describing transactions comprising at least one of product identity, quantity of units of product, and points along the supply chain of the product during the transactions.

### CROSS REFERENCE TO RELATED APPLICATIONS

None

### FIELD OF THE INVENTION

The present disclosure is in the field of distribution of agricultural products. More particularly, the present disclosure provides systems and methods of using smart contracts, non-fungible tokens, and blockchains to store information about transactions for agricultural products and assure integrity of the information along supply chains of the products to the end consumer.

### BACKGROUND

Modern agronomy, plant breeding, agrochemicals such as pesticides and fertilizers, and technological developments have sharply increased crop yields, but have also contributed to ecological and environmental damage, with consequent public criticism and doubt. Selective breeding and modern practices in animal husbandry have similarly increased the output of meat but have raised concerns about animal welfare and environmental damage.

Environmental issues include contributions depletion of aquifers, deforestation, antibiotic resistance, and other agricultural pollution. Agriculture is both a cause of and sensitive to environmental degradation, such as biodiversity loss, desertification, and soil degradation, all of which can cause decreases in crop yield.

Buyers of agricultural products seek assurance about quality of the products they purchase as well as the integrity of the processes of growing, harvesting, packaging, inspection, and delivery of the products. When the agricultural products are non-consumable, such as fertilizer or animal feed, buyers may have similar concerns. The agribusiness needs transparent and secure ways to track the supply chains of agricultural products and services which could improve trust and confidence in the food industry.

### BRIEF DESCRIPTION OF THE FIGURE

FIG. 1 is a block diagram of a system for utilizing blockchain-based non-fungible tokens to track movement of goods through supply chains according to an embodiment of the present disclosure.

### DETAILED DESCRIPTION

Systems and methods described herein provide for non-fungible tokens (NFT) to be created and associated with transactions involving agricultural products. The NFTs are stored on a blockchain, assuring immutability of data. The NFTs contain information about individual transactions as agricultural products in the transactions move along a supply change from farm through processing and shipment to final consumer. The NFTs provide for tracking of the goods and monitoring other aspects of the associated transaction as the goods move along the supply chain.

A smart contract is created that defines rules for the NFTs. Each NFT represents a unique product, and the smart contract contains rules for the creation, transfer, and ownership of NFTs. The smart contract also verifies that the products in a transaction are genuine and meet certain criteria, such as being organic or sustainably sourced.

The NFTs are created by the smart contract that is programmed to capture and store data about agricultural products and services for sale under the system. The data includes such information as product origin, production methods, and certifications. The smart contract may also include algorithms for tracking the movement of the product along the supply chain from farm or factory to end consumer. Such tracking may promote greater confidence in the quality of products and integrity of processes producing and delivering those products.

Online and traditional vendors may use the NFTs provided herein to ensure authenticity and quality of the products the retailers sell. End consumers may use NFTs to verify the origin and production methods of the products they purchase.

The system may also include incentives for sellers and buyers to participate in the system, such as discounts or rewards for purchasing or selling verified products. The system on the blockchain provides a transparent and secure way to track the supply chain of agricultural products and services, which could improve trust and confidence in the industry.

Under the system, buyers may verify the authenticity of the NFTs and their associated products. This may be done by verifying the data stored on the blockchain against the physical products.

Rewards for verified products may also be made part of the system. To incentivize sellers to create and buyers to purchase verified products, the system may include a reward structure. Vendors may be awarded discounts on fees or commissions for creating and selling verified products. Buyers may be given discounts on purchases of verified products.

The system may allow for tracking of products throughout the supply chain. Such tracking may provide transparency and visibility for the benefit of end consumers but also distributors, warehouse operators, and shipping companies. The transparency may increase trust and confidence in food safety.

Incentivizing sellers, buyers, and other parties along the supply chain to participate may help to ensure the quality and authenticity of agricultural products. It may also increase transparency and trust in the industry and promote sustainable and ethical practices The system allows for the tracking of agricultural products throughout the supply chain and the submission of those supply chains to the patent office.

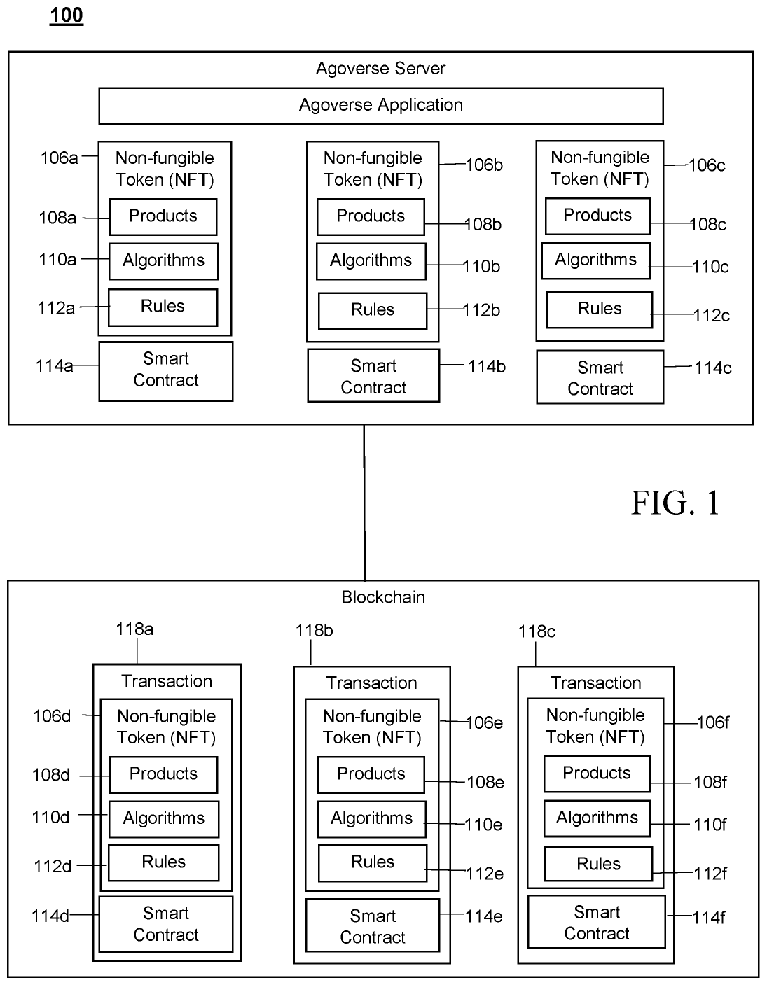

Turning to the FIGURE, FIG. 1 is a block diagram of a blockchain-based system for utilizing non-fungible tokens to track movement of goods through supply chains according to an embodiment of the present disclosure. FIG. 1 illustrates components and interactions of an exemplary system 100. The system 100 and associated methods may be referred to commercially as Agoverse.

The system 100 comprises an Agoverse server 102 and an Agoverse application 104 executing thereon, referred to hereinafter respectively for brevity as the server 102 and the application 104. The server 102 may comprise multiple physical computing devices situated at multiple geographic locations. The application 104 may comprise multiple software applications or modules executing on multiple devices. 108

The system 100 also comprises non-fungible tokens (NFT) 106a-f, products 108a-f, algorithms 110a-f, and rules 112a-f. The system 100 also comprises smart contracts 114a-f, a blockchain 116, and transactions 118a-c.

The non-fungible tokens (NFT) 106a-f, products 108a-f, algorithms 110a-f, rules 112a-f, and smart contracts 114a-f are depicted partially with the server 102 and partially with the blockchain 116. The components are depicted in this manner to represent that some NFT 106a-c, their components, and accompanying smart contract 116a-c are in the process of being constructed as new transactions are conceived and are launched but before they are inserted into the blockchain 116.

Other NFT 106d-f, their components, and accompanying smart contract 116d-f have been launched, are associated with transactions 118a-c, and have been inserted into the blockchain 116. This is the difference between the upper part of FIG. 1 and the lower part of FIG. 1.

Products 108a-f, algorithms 110a-f, and rules 112a-f are explained above and are linked with the particular NFT 106a-f they are covered by. They are further linked to their particular transaction 118a-c once the transaction 118a-c is instantiated and inserted into the blockchain 116.

Each NFT 106a-f has its own dedicated smart contract 114a-f or instantiation of a smart contract that serves as a template for transactions of a certain type that may have the same products 108a-f, algorithms 110a-f, rules 112a-f, vendor, buyer, distributor, pricing, and/or quantity of units. The smart contracts 114a-f and their rules 112a-f exist in part to provide standardization to the system 100 and facilitate commerce as well as the other benefits described above.

In an embodiment, a system for utilizing non-fungible tokens to track movement of goods through supply chains is provided. The system comprises a computer and an application executing thereon that creates a smart contract for deployment on a blockchain, the smart contract directed to defining rules for non-fungible tokens (NFT), wherein each NFT represents a unique agricultural product. The system also programs the smart contract to capture and store data in the NFTs about the products. The system also programs the smart contract to include algorithms in the NFTs for tracking movement of the products through their supply chains. The system also deploys the smart contract in the blockchain.

The blockchain stores data describing transactions comprising at least one of product identity, quantity of units of product, and points along the supply chain of the product during the transactions. The defined rules concern at least one of creation, transfer, and ownership of NFTs.

The smart contract further stores information about suppliers, manufacturers, and retailers of products represented by NFTs. The system verifies authenticity of NFTs resident on the blockchain upon request.

The system provides incentives to buyers and sellers of agricultural products to participate in the system, the incentives comprising at least one of discounts, rewards, and commissions. The smart contract is configured to verify that products covered by NFTs are genuine and meet criteria comprising at least one of being organic and sustainably sourced.

In another embodiment, a method of creating a non-fungible token representing a product on a blockchain is provided. The method comprises a computer noting presence of a newly introduced product on a supply chain. The method also comprises the computer directing a smart contract to create a non-fungible token (NFT) for the product. The method also comprises the computer directing the smart contract to insert information into the NFT regarding the product. The method also comprises the computer deploying the smart contract to associate the NFT with a blockchain.

The method also comprises the computer directing the smart contract to configure the NFT to be trackable as associated products move through the supply chain. The method also comprises the computer directing the smart contract to include algorithms in the NFTs to aid in the tracking.

The method also comprises the computer directing the smart contract to observe rules about creation of NFTs, the rules concerning at least one of transfer and ownership of NFTs. The information inserted into the NFT comprises at least one of product origin, product production methods, and product certifications.

The method also comprises the smart contract storing information about suppliers, manufacturers, and retailers of products represented by the NFT. The method also comprises the computer directing the smart contract to instantiate the NFT for transactions involving agricultural products distributed via the supply chain.

In yet another embodiment, a system for supporting integrity in blockchain-related transactions is provided. The system comprises a computer and an application executing thereon that receives a request from a client device to verify authenticity of a non-fungible token (NFT) on a blockchain, the NFT representing a product in a transaction. The system also locates the NFT on the blockchain and extracts data stored in the NFT describing the transaction. The system also provides at least portions of the extracted data to the client device and instructs the client device to verify the at least portions of data against physical products.

The client device is in possession of a one of a distributor, warehouse operator, and purchaser of the product. The data comprises at least one of product name, quantity of units in the transaction, location of product in a supply chain, and progression to-date of the product on the supply chain.

An NFT is instantiated for each transaction for at least a purpose of supporting integrity of the transaction. The NFT is created by a smart contract when the product enters the supply chain for the transaction. The smart contract defines rules for NFTs associated with at least one of creation, transfer, and ownership of NFTs, the rules at least partially directed to supporting integrity of transactions.

What is claimed is:

1. A system for utilizing non-fungible tokens to track movement of goods through supply chains, comprising:
a computer and an application executing thereon that:
creates a smart contract for deployment on a blockchain, the smart contract directed to defining rules for non-fungible tokens (NFT), wherein
each NFT represents a unique agricultural product;
programs the smart contract to capture and store data in the NFTs about the products;
programs the smart contract to include algorithms in the NFTs for tracking movement of the products through their supply chains; and
deploys the smart contract in the blockchain.

2. The system of claim 1, wherein the blockchain stores data describing transactions comprising at least one of product identity, quantity of units of product, and points along the supply chain of the product during the transactions.

3. The system of claim 1, wherein the defined rules concern at least one of creation, transfer, and ownership of NFTs.

4. The system of claim 1, wherein the smart contract further stores information about suppliers, manufacturers, and retailers of products represented by NFTs.

5. The system of claim 1, wherein the system verifies authenticity of NFTs resident on the blockchain upon request.

6. The system of claim 1, wherein the system provides incentives to buyers and sellers of agricultural products to participate in the system, the incentives comprising at least one of discounts, rewards, and commissions.

7. The system of claim 1, wherein the smart contract is configured to verify that products covered by NFTs are genuine and meet criteria comprising at least one of being organic and sustainably sourced.

8. A method of creating a non-fungible token representing a product on a blockchain, comprising:
a computer noting presence of a newly introduced product on a supply chain;
the computer directing a smart contract to create a non-fungible token (NFT) for the product;
the computer directing the smart contract to insert information into the NFT regarding the product;
the computer deploying the smart contract to associate the NFT with a blockchain.

9. The method of claim 8, further comprising the computer directing the smart contract to configure the NFT to be trackable as associated products move through the supply chain.

10. The method of claim 9, further comprising the computer directing the smart contract to include algorithms in the NFTs to aid in the tracking.

11. The method of claim 8, further comprising the computer directing the smart contract to observe rules about creation of NFTs, the rules concerning at least one of transfer and ownership of NFTs.

12. The method of claim 8, wherein the information inserted into the NFT comprises at least one of product origin, product production methods, and product certifications.

13. The method of claim 8, further comprising the smart contract storing information about suppliers, manufacturers, and retailers of products represented by the NFT.

14. The method of claim 8, further comprising the computer directing the smart contract to instantiate the NFT for transactions involving agricultural products distributed via the supply chain.

15. A system for supporting integrity in blockchain-related transactions, comprising:
a computer and an application executing thereon that:
receives a request from a client device to verify authenticity of a non-fungible token (NFT) on a blockchain, the NFT representing a product in a transaction,
locates the NFT on the blockchain,
extracts data stored in the NFT describing the transaction,
provides at least portions of the extracted data to the client device, and
instructs the client device to verify the at least portions of data against physical products.

16. The system of claim 15, wherein the client device is in possession of a one of a distributor, warehouse operator, and purchaser of the product.

17. The system of claim 15, wherein the data comprises at least one of product name, quantity of units in the transaction, location of product in a supply chain, and progression to-date of the product on the supply chain.

18. The system of claim 15, wherein an NFT is instantiated for each transaction for at least a purpose of supporting integrity of the transaction.

19. The system of claim 15, wherein the NFT is created by a smart contract when the product enters the supply chain for the transaction.

20. The system of claim 19, wherein the smart contract defines rules for NFTs associated with at least one of creation, transfer, and ownership of NFTs, the rules at least partially directed to supporting integrity of transactions.
